(19) United States
(12) Patent Application Publication
(10) Pub. No.: US 2011/0320979 A1
(43) Pub. Date: Dec. 29, 2011

(54) METHOD AND APPARATUS FOR CREATING A TO-DO ITEM BASED ON SELECTION OF A FUNCTION TO BE PERFORMED BY AN APPLICATION

(75) Inventor: Roope Rainisto, Helsinki (FI)

(73) Assignee: Nokia Corporation

(21) Appl. No.: 12/822,561

(22) Filed: Jun. 24, 2010

(51) Int. Cl. G06F 3/048

(52) U.S. Cl. 715/825; 715/835

(57) ABSTRACT

An apparatus may include a to-do item creator configured to create a to-do item based on selection of a function to be performed by an application using an operational characteristic. An application multi-tasking module may allow for multi-tasking of applications as well as movement of applications from a multi-tasking environment to a to-do item list. Further, a to-do item manager may manage the to-do item list and/or allow the user to select a to-do item to thereby perform the function with the application using the operational characteristic. Accordingly, creation and use of to-do items may be simplified.

### TECHNOLOGICAL FIELD

Embodiments of the present invention relate generally to creating to-do items and, more particularly, relate to an apparatus, method and a computer program product configured to create to-do items based on selection of a function to be performed by an application.

### BACKGROUND

The modern communications era has brought about a tremendous expansion of wireline and wireless networks. Computer networks, television networks, and telephony networks are experiencing an unprecedented technological expansion, fueled by consumer demand. Wireless and mobile networking technologies have addressed related consumer demands, while providing more flexibility and immediacy of information transfer.

Along with recent developments in networking there have also been technological advances in scheduling and organization which have sought to allow users to record tasks in the form of appointments and to-do items. Accordingly a user may be able to electronically organize his time and activities. However, the ability of present electronic systems to provide users with organizational benefits is limited by the manual entry requirements associated with present systems. In this regard, the effort involved in using present systems may discourage users from taking full advantage of these systems. Accordingly, more user-friendly and efficient organizational systems, methods, and apparatuses may be desirable.

### BRIEF SUMMARY

A method, apparatus and computer program product are therefore provided that may create a to-do item based on selection of a function to be performed by an application using an operational characteristic, thereby supporting the development of more user-friendly and efficient organization systems.

In an example embodiment, an improved apparatus comprises at least one processor and at least one memory including computer program code, the at least one memory and the computer program code configured to, with the processor, cause the apparatus to provide for selection of a function to be performed by an application using an operational characteristic, create a to-do item based on selection of the function, and provide for selection of the to-do item to thereby perform the function with the application using the operational characteristic.

In an additional example embodiment a method comprises providing for selection of a function to be performed by an application using an operational characteristic, creating a to-do item based on selection of the function via a processor, and providing for selection of the to-do item to thereby perform the function with the application using the operational characteristic.

In a further example embodiment a computer program product comprises at least one computer-readable storage medium having computer-executable program code portions stored therein, the computer-executable program code portions comprising program code instructions providing for selection of a function to be performed by an application using an operational characteristic, program code instructions for creating a to-do item based on selection of the function, and program code instructions providing for selection of the to-do item to thereby perform the function with the application using the operational characteristic.

Accordingly, embodiments of the present invention may create a to-do item based on selection of a function to be performed by an application using an operational characteristic, thereby facilitating creation and use of to-do items.

### BRIEF DESCRIPTION OF THE SEVERAL VIEWS OF THE DRAWING(S)

Having thus described embodiments of the present disclosure in general terms, reference will now be made to the accompanying drawings, which are not necessarily drawn to scale, and wherein:

FIG. 1 illustrates a schematic block diagram of a system according to an example embodiment of the present invention;

FIG. 2 illustrates a schematic block diagram of an apparatus configured to create a to-do item based on selection of a function to be performed by an application according to an example embodiment of the present invention;

FIG. 3 illustrates the user terminal of FIG. 1 when the user terminal is creating a to-do item within a media player application according to an example embodiment of the present invention;

FIG. 4 illustrates the user terminal of FIG. 1 when the user terminal is creating a to-do item within an email application according to an example embodiment of the present invention;

FIG. 5 illustrates the user terminal of FIG. 1 when the user terminal is creating a to-do item within a multi-tasking environment according to an example embodiment of the present invention;

FIG. 6 illustrates the multi-tasking environment of FIG. 5 in which the to-do item has been added to a to-do list according to an example embodiment of the present invention; and

FIG. 7 illustrates a flowchart of the operations performed in creating a to-do item based on selection of a function to be performed by an application in accordance with an example embodiment of the present invention.

### DETAILED DESCRIPTION

Some embodiments of the present invention will now be described more fully hereinafter with reference to the accompanying drawings, in which some, but not all embodiments of the invention are shown. Indeed, various embodiments of the invention may be embodied in many different forms and should not be construed as limited to the embodiments set forth herein. Like reference numerals refer to like elements throughout. As used herein, the terms “data,” “content,” “information” and similar terms may be used interchangeably to refer to data capable of being transmitted, received and/or stored in accordance with embodiments of the present invention. Moreover, the term “exemplary”, as used herein, is not provided to convey any qualitative assessment, but instead merely to convey an illustration of an example. Thus, use of any such terms should not be taken to limit the spirit and scope of embodiments of the present invention.

As used herein, the term ‘circuitry’ refers to (a) hardware-only circuit implementations (for example, implementations in analog circuitry and/or digital circuitry); (b) combinations of circuits and computer program product(s) comprising software and/or firmware instructions stored on one or more computer readable memories that work together to cause an apparatus to perform one or more functions described herein; and (c) circuits, such as, for example, a microprocessor(s) or a portion of a microprocessor(s), that require software or firmware for operation even if the software or firmware is not physically present. This definition of ‘circuitry’ applies to all uses of this term herein, including in any claims. As a further example, as used herein, the term ‘circuitry’ also includes an implementation comprising one or more processors and/or portion(s) thereof and accompanying software and/or firmware. As another example, the term ‘circuitry’ as used herein also includes, for example, a baseband integrated circuit or applications processor integrated circuit for a mobile phone or a similar integrated circuit in a server, a cellular network device, other network device, and/or other computing device.

As indicated above, embodiments of the present invention may be employed in methods, apparatuses and computer program products configured to create a to-do item based on selection of a function to be performed by an application. A to-do item, as used herein, refers to an activity, task, or event requiring performance of an action to complete the to-do item. In some embodiments the to-do items may require performance of the action starting at a particular time and/or date and/or completion of the to-do item by a certain time and/or date. Further, an application, as used herein, refers to software, programs, and other instructions which are configured to perform one or more functions, and which may be stored in memory in some embodiments. For example, an application, upon execution, may perform a function which satisfies the action required to complete a to-do item.

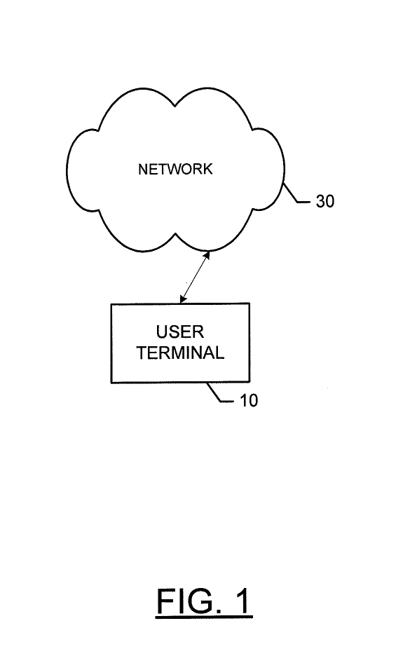

In this regard, for example, FIG. 1 illustrates a block diagram of a system that may benefit from embodiments of the present invention. It should be understood, however, that the system as illustrated and hereinafter described is merely illustrative of one system that may benefit from embodiments of the present invention and, therefore, should not be taken to limit the scope of embodiments of the present invention.

As shown in FIG. 1, an embodiment of a system in accordance with an example embodiment of the present invention may include a user terminal 10. The user terminal 10 may be any of multiple types of fixed or mobile communication and/or computing devices such as, for example, portable digital assistants (PDAs), pagers, mobile televisions, mobile telephones, gaming devices, laptop computers, personal computers (PCs), cameras, camera phones, video recorders, audio/video players, radios, global positioning system (GPS) devices, or any combination of the aforementioned, and other types of voice and text communications systems, which employ embodiments of the present invention.

In some embodiments the user terminal 10 may be capable of communicating with other devices, either directly, or via a network 30. The network 30 may include a collection of various different nodes, devices or functions that may be in communication with each other via corresponding wired and/or wireless interfaces. As such, the illustration of FIG. 1 should be understood to be an example of a broad view of certain elements of the system and not an all inclusive or detailed view of the system or the network 30. Although not necessary, in some embodiments, the network 30 may be capable of supporting communication in accordance with any one or more of a number of first-generation (1G), second-generation (2G), 2.5G, third-generation (3G), 3.5G, 3.9G, fourth-generation (4G) mobile communication protocols, Long Term Evolution (LTE), and/or the like. Thus, the network 30 may be a cellular network, a mobile network and/or a data network, such as a local area network (LAN), a metropolitan area network (MAN), and/or a wide area network (WAN), for example, the Internet. In turn, other devices such as processing elements (for example, personal computers, server computers or the like) may be included in or coupled to the network 30. By directly or indirectly connecting the user terminal 10 and the other devices to the network 30, the user terminal and/or the other devices may be enabled to communicate with each other, for example, according to numerous communication protocols including Hypertext Transfer Protocol (HTTP) and/or the like, to thereby carry out various communication or other functions of the mobile terminal and the other devices, respectively. As such, the user terminal 10 and the other devices may be enabled to communicate with the network 30 and/or each other by any of numerous different access mechanisms. For example, mobile access mechanisms such as wideband code division multiple access (W-CDMA), CDMA2000, global system for mobile communications (GSM), general packet radio service (GPRS) and/or the like may be supported as well as wireless access mechanisms such as wireless LAN (WLAN), Worldwide Interoperability for Microwave Access (WiMAX), WiFi, ultra-wide band (UWB), Wibree techniques and/or the like and fixed access mechanisms such as digital subscriber line (DSL), cable modems, Ethernet and/or the like. Thus, for example, the network 30 may be a home network or other network providing local connectivity.

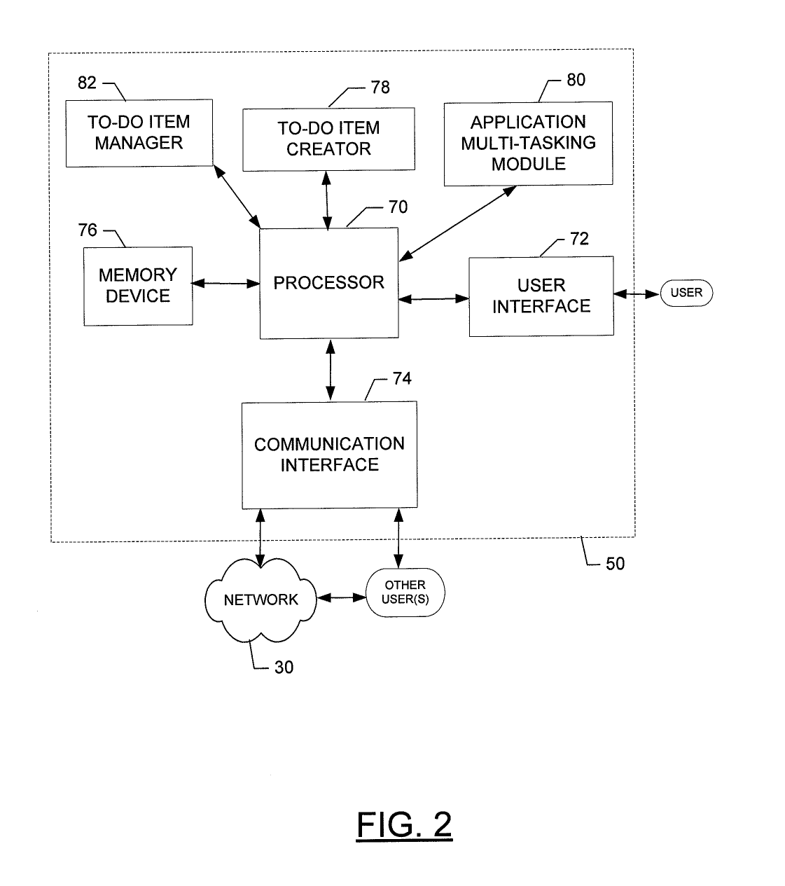

In an example embodiment, an apparatus 50 is provided that may be employed by devices performing example embodiments of the present invention. The apparatus 50 may be embodied, for example, as any device hosting, including, controlling or otherwise comprising the user terminal 10. However, embodiments may also be embodied on a plurality of other devices such as for example where instances of the apparatus 50 may be embodied on the network 30. As such, the apparatus 50 of FIG. 2 is merely an example and may include more, or in some cases less, than the components shown in FIGS. 2.

With further regard to FIG. 2, the apparatus 50 is configured to create a to-do item based on selection of a function to be performed by an application. The apparatus 50 may include or otherwise be in communication with a processor 70, a user interface 72, a communication interface 74 and a memory device 76. The memory device 76 may include, for example, volatile and/or non-volatile memory. The memory device 76 may be configured to store information, data, files, applications, instructions or the like. For example, the memory device 76 could be configured to buffer input data for processing by the processor 70. Additionally or alternatively, the memory device 76 could be configured to store instructions for execution by the processor 70.

The processor 70 may be embodied in a number of different ways. For example, the processor 70 may be embodied as one or more of various processing means such as a coprocessor, a microprocessor, a controller, a digital signal processor (DSP), processing circuitry with or without an accompanying DSP, or various other processing devices including integrated circuits such as, for example, an ASIC (application specific integrated circuit), an FPGA (field programmable gate array), a hardware accelerator, a special-purpose computer chip, or the like. In an example embodiment, the processor 70 may be configured to execute instructions stored in the memory device 76 or otherwise accessible to the processor. Alternatively or additionally, the processor 70 may be configured to execute hard coded functionality. As such, whether configured by hardware or software methods, or by a combination thereof, the processor 70 may represent an entity (for example, physically embodied in circuitry) capable of performing operations according to embodiments of the present invention while configured accordingly. Thus, for example, when the processor 70 is embodied as an ASIC, FPGA or the like, the processor 70 may be specifically configured hardware for conducting the operations described herein. Alternatively, as another example, when the processor 70 is embodied as an executor of software instructions, the instructions may specifically configure the processor to perform the algorithms and/or operations described herein when the instructions are executed. However, in some cases, the processor 70 may be a processor of a specific device (for example, a mobile terminal or network device such as a server) adapted for employing embodiments of the present invention by further configuration of the processor by instructions for performing the algorithms and/or operations described herein. The processor 70 may include, among other things, a clock, an arithmetic logic unit (ALU) and logic gates configured to support operation of the processor. In some embodiments the processor 70 may run an operating system configured to execute the applications.

Meanwhile, the communication interface 74 may be any means such as a device or circuitry embodied in either hardware, software, or a combination of hardware and software that is configured to receive and/or transmit data from/to a network and/or any other device or module in communication with the apparatus 50. In this regard, the communication interface 74 may include, for example, an antenna (or multiple antennas) and supporting hardware and/or software for enabling communications with a wireless communication network (for example, network 30). In fixed environments, the communication interface 74 may alternatively or also support wired communication. As such, the communication interface 74 may include a communication modem and/or other hardware/software for supporting communication via cable, digital subscriber line (DSL), universal serial bus (USB), Ethernet, High-Definition Multimedia Interface (HDMI) or other mechanisms. Furthermore, the communication interface 74 may include hardware and/or software for supporting communication mechanisms such as BLUETOOTH®, Infrared, UWB, WiFi, and/or the like, which are being increasingly employed in connection with providing home connectivity solutions.

The user interface 72 may be in communication with the processor 70 to receive an indication of a user input at the user interface and/or to provide an audible, visual, mechanical or other output to the user. As such, the user interface 72 may include, for example, a keyboard, a mouse, a joystick, a display, a touch screen, a microphone, a speaker, a ringer or other input/output mechanisms.

The processor 70 may comprise user interface circuitry configured to control at least some functions of one or more elements of the user interface 72, such as, for example, the speaker, the ringer, the microphone, the display, and/or the like. The processor 70 and/or user interface circuitry comprising the processor 70 may be configured to control one or more functions of one or more elements of the user interface 72 through computer program instructions (for example, software and/or firmware) stored on a memory accessible to the processor 70 (for example, memory device 76, and/or the like).

The apparatus 50 may further comprise a to-do item creator 78 which is configured to create a to-do item based on selection of a function to be performed by an application. The processor 70 may be embodied as, include or otherwise control the to-do item creator 78. In some embodiments the to-do item creator 78 may also provide for selection of a function to be performed by an application using an operational characteristic. An operational characteristic, as used herein, refers to data or information which is inputted, outputted, processed, or otherwise used by an application in performing a function.

To-do items may be created based on selection of a variety of functions as performed by a variety of applications. In this regard, examples of functions as performed by example applications are described herein. It should be understood that any number of various types of functions as performed by any number of various applications may be used to create to-do items. Thus, the examples presented herein are for example purposes only. However, in some embodiments of the apparatus 50, creation of to-do items will be limited to certain functions. For instance, in some embodiments of the application a to-do item which reminds a user to perform the function of bolding a block of text in a word processing application may be of little value. Accordingly, in some embodiments of the invention, creation of to-do items is limited to selected functions which are performed by selected applications.

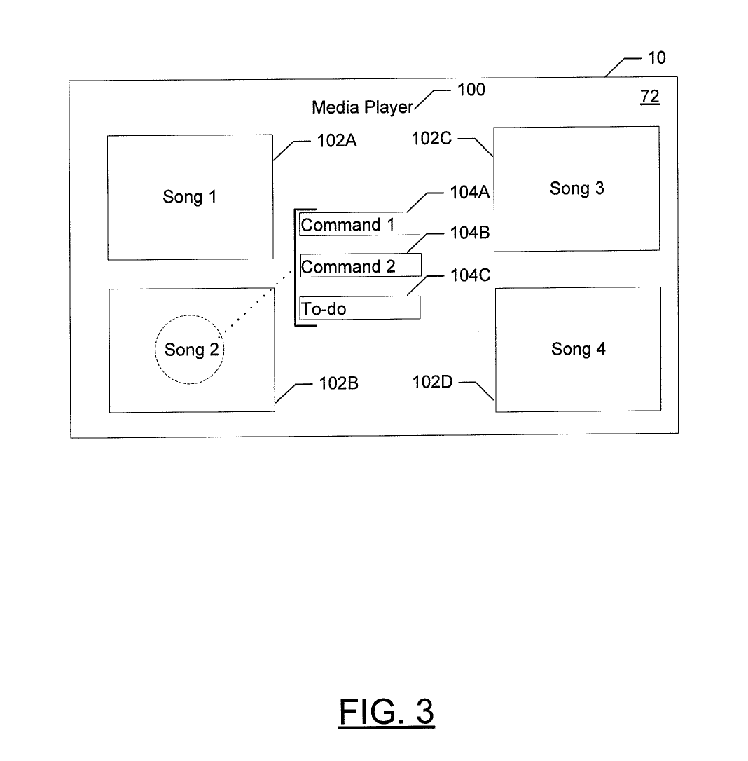

For example, FIG. 3 illustrates the user terminal 10 when it embodies the apparatus 50 and the user terminal is executing a media player application 100. As illustrated, the media player application 100 may display songs 102A-D which the media player application may play when the user selects one or more of the songs. In this case, the function performed by the media player application 100 is playing media, and the songs 102A-D constitute the operational characteristics which are used by the media player application in performing this function.

As is further illustrated in FIG. 3, the user may select a play function to be performed by the media player application 100 to create a to-do item based on selection of the function. Various methods of selecting the function to create a to-do item are possible, as will be discussed in further detail below. In the illustrated embodiment the user wants to create a to-do item to listen to Song 2 102B. Accordingly, the user selects the play function of the media player application 100. As illustrated, the user may select the play function by selecting Song 2 102B, which serves as an interactive component of the media player application 100. However, rather than simply tapping on Song 2 102B, which would cause the media player application 100 to play Song 2, the illustrated embodiment of the user terminal 10 allows the user to select from one or more secondary functions 104A-C by pressing and holding Song 2 for a longer period of time. In other words, the secondary functions may be accessed by a relatively long press on the user interface 72, rather than a relatively quick tap which implements the primary function of playing the selected song. The secondary functions may include a first command 104A and a second command 104B, which may include other functionality which may be unrelated hereto. However, one of the secondary functions 104C may allow the user to create a to-do item based on selection of the play function. Note that a relatively long press on the user interface 72 is just one embodiment of a method to select a function performed by an application. In this regard, functions may be selected using various other methods. For example, an element displayed by the user interface 72 may be dragged and dropped to another element such as a “further options” button displayed on the user interface to access secondary functions. Secondary functions may also be accessed by other methods in some embodiments, such as single tapping/clicking, double tapping/clicking, right clicking with a mouse or virtual mouse, swipe action, pinch action, etcetera. Thereby, various methods for selecting functions may be employed in various embodiments.

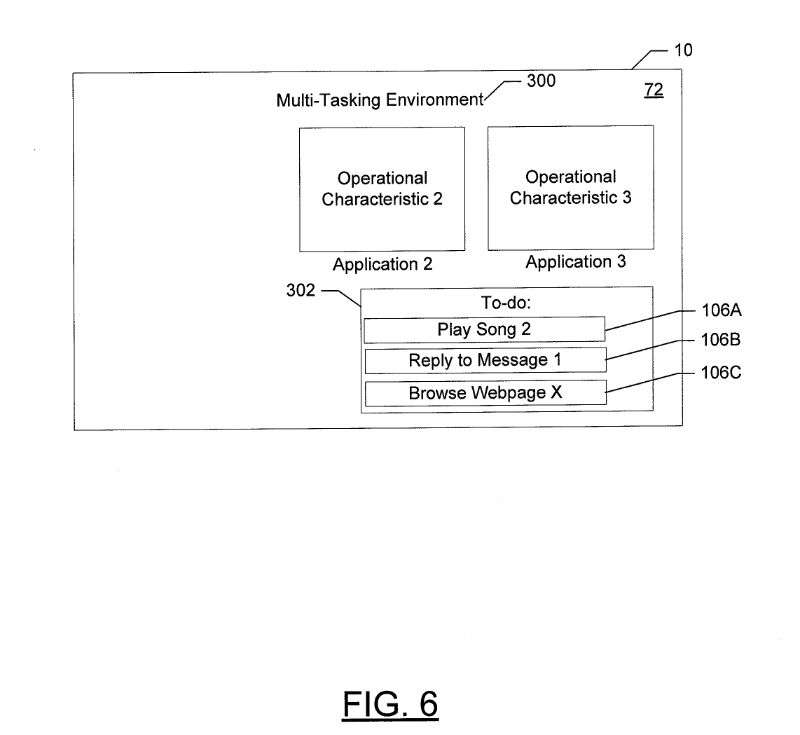

As illustrated in FIG. 6, the to-do item creator 78 may also create a label for the to-do item. For example, the to-do item 106A created using the above-described process has been given the label “Play Song 2.” The to-do item label assigned to each to-do item may in some embodiments be selected based on the view title of the next view which would occur if the function of the application were to be selected normally. For example, in FIG. 3 if the user had selected Song 2 with a single tap, the next view may have been “Now Playing Song 2,” or something similar. Accordingly, the to-do item label may be indicative of the next view which would occur if the primary function were to be selected and may thereby read “Play Song 2,” as shown in FIG. 6. Thus, labels may be assigned to to-do items based on the respective application, the function to be performed by the application, and/or the operational characteristic being used to perform the function. However, as may be understood, various other methods for assigning labels to the to-do items may be employed. For example, in some embodiments the labels may constitute a screenshot of the next view which would be seen by selecting the primary function, the cover art for a piece of media, or a manually entered title created by the user.

In another exemplary embodiment (not shown), the user may be listening to another song, such as Song 3, and then decide to create a to-do item to listen to the song at a later point in time. Thus, there may now be two songs to be played later, Song 2 and Song 3, on the to-do item list. Instead of displaying separate to-do items for both songs, the two to-do items may be shown with a single label. Thereby, by selecting the single to-do item, the two songs may in some embodiments be played one after the other in sequence. The sequence may in some embodiments be based on the order in which the songs are added to the to-do item list, whereas in other embodiments the sequence may be based on alphabetical order or other sequences. Thereby, in some embodiments the user could be provided with the option to decide whether or not he or she wants a single to-do item to be created when multiple to-do items of the same type or category are added in such circumstances.

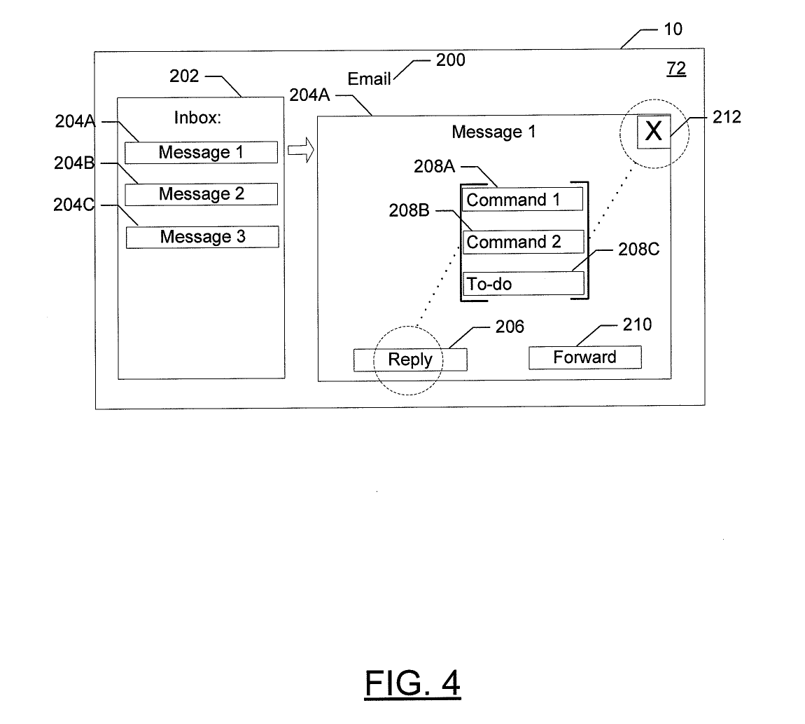

Although one method for creating a to-do item using the to-do item creator 78 was described above, various other methods may be used to create to-do items in some embodiments. For example, FIG. 4 illustrates the user terminal 10 when it is executing an email application 200. The email application 200 may display an inbox 202 using the user interface 72 which allows the user to select and view messages 204A-C. In the illustrated embodiment the email application 200 is displaying Message 1 204A. In a manner similar to that described above with respect to Song 2 102B, the user may create a to-do item. In particular, the user may select a reply button 206 to create a to-do item to reply to Message 1 204A. As further described above, in some embodiments the user may tap the reply button 206 to reply to the message immediately as a primary function, or the user may invoke secondary functions 208A-C by pressing the reply button for a longer period of time. Similar functionality may be provided with respect to other functions such as through using a forward button 210 to create a to-do item to forward Message 1 204A.

However, the secondary functions 208A-C may be invoked in some embodiments of the apparatus 50 using the to-do item creator 78 without selecting an interactive component of the application configured to perform the desired function. For example, the to-do item may be created through a separate to-do button in some embodiments. Further, in the illustrated embodiment the secondary functions 208A-C may be invoked by selecting a close button 212 of the email application 200. The close button 212 may in some embodiments close the message (Message 1 204A, as illustrated) as a primary function when it is tapped and invoke the secondary functions 208A-C when it is pressed for a longer period of time. Thereby, the user may be able to select the To-Do secondary function 208C and create a to-do item for replying to Message 1 204A. Accordingly, a Reply to Message 1 to-do item 106B may be created by either of the above-described methods of creating a to-do item, as illustrated in FIGS. 6.

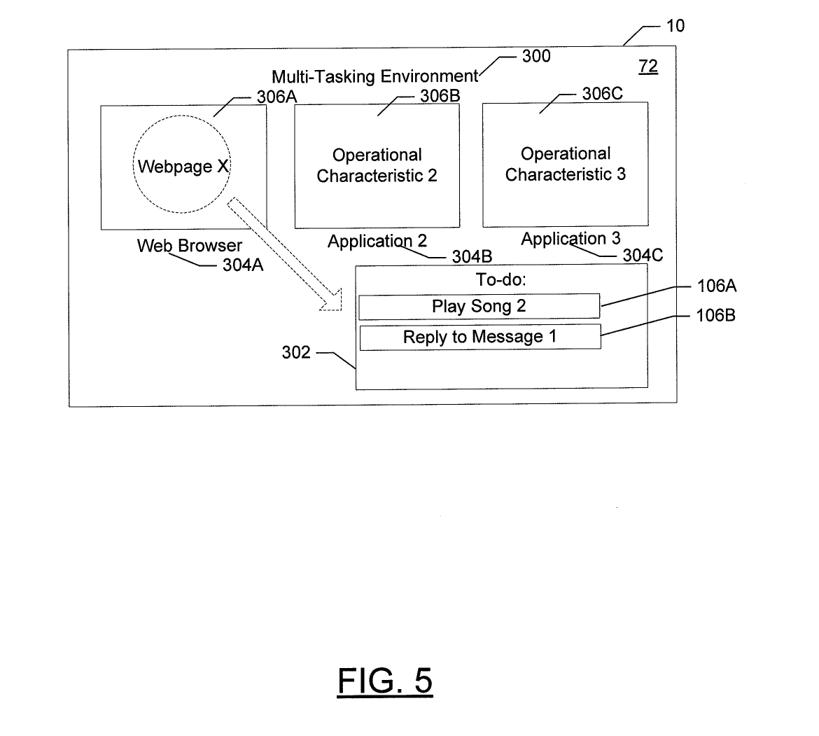

In a further embodiment, as illustrated in FIG. 5, to-do items may be created by alternative methods. In particular, the to-do item creator 78 may allow the user terminal 10 to provide for movement of an application from a multi-task environment 300 to a to-do item list 302. Note that various embodiments of methods for moving an application from the multi-tasking environment 300 to the to-do item list 302 may be employed. For example, an application may be moved from the multi-tasking environment 300 to the to-do item list 302 by a relatively long press on the user interface 72, dragging and dropping the application into the to-do item list, single tapping/clicking, double tapping/clicking, right clicking with a mouse or virtual mouse, swipe action, pinch action, etcetera. Thereby, various methods for moving an application from the multi-tasking environment 300 to the to-do item list 302 may be employed in various embodiments. As illustrated in FIG. 2, apparatus 50 may include an application multi-tasking module 80 which controls multi-tasking of the applications. The processor 70 may be embodied as, include or otherwise control the multi-tasking module 80. Multi-tasking, as used herein, refers to use of software environments wherein the user has access to various applications and/or content sources and the user can thereby launch and run one or more of these items simultaneously and swap between the various ongoing items through one or more user interface methods.

Thus, FIG. 5 illustrates three applications 304A-C which are running in the multi-tasking environment 300 and which are performing respective functions on respective operational characteristics 306A-C. By way of example, the user interface 72 may display a Web Browser application 304A in the multi-tasking environment 300. As illustrated, the Web Browser application 304A is displaying Webpage X 306A. Thus, with regard to the Web Browser application 304A, the function of application is to display content. In particular, the Web Browser application 304A is displaying Webpage X 306A, which is the operational characteristic in this case.

If the user desires to create a to-do item based on the display of Webpage X 306A, so that he or she can read Webpage X later, the embodiment of the user terminal 10 illustrated in FIG. 5 allows the user to move the Web Browser 304A into the to-do item list 302. For example, the user may simply press on icon for the Web Browser 304A and drag the web browser across the user interface 72 to the to-do item list 302. Thus, in some embodiments the user may drag a user interface element, such as an icon, to the to-do item list 302 and/or a user interface element representing a to-do item list in order to create a to-do item. For example, a user could drag or otherwise move an application item, calendar item, or other user interface element to the to-do item list 302 or an icon or other user interface element representing the to-do item list to create a to-do item. Thus, various embodiments of methods for creating to-do items may be employed. As illustrated in FIG. 6, when the Web Browser application 304A is moved to the to-do list 302, a to-do item 106C including the label “Browse Webpage X,” for example, may be created. The to-do item 106C may preserve the state of Webpage X 306A so that the user can view the webpage later as will be discussed below. As further illustrated, in some embodiments the Web Browser application 304A may be removed from the multi-tasking environment 300 when the to-do item 106C is created.

Returning to FIG. 2, the apparatus 50 may further comprise a to-do item manager 82. The processor 70 may be embodied as, include or otherwise control the to-do item manager 82. The to-do item manager 82 may manage the to-do items 106A-C. For example, the to-do item manager 82 may provide for selection of the to-do items 106A-C by organizing the to-do items in the to-do item list 302. When a to-do item 106A-C is selected, the to-do item performs the associated function with the respective application using the relevant operational characteristic. For example, when the Play Song 2 to-do item 106A is selected, the media player application 100 launches and plays Song 2 102B. Further, when the Reply to Message 1 to-do item 106B is selected, the email application 200 drafts an email replying to message 1 204A. For example, the email replying to Message 1 204A may be addressed to the sender of Message 1, the title of the email may indicate that it is a reply to Message 1, and the email may quote the text of Message 1 in the body of the email. Accordingly, the user may not need to retype this information, which may thereby save the user time. Additionally, when the user selects the Browse Webpage X to-do item 106C, the Web Browser 304A launches and displays Webpage X 306A. In some embodiments the state of Webpage X may be preserved such that the webpage appears as it did at the time of creating the to-do item 106C. However, in other embodiments Webpage X may be updated to the present version of the webpage.

In another exemplary embodiment a user may be watching a video or a movie, using a movie playing application, for example Application 2 of FIG. 6 may comprise a movie playing application, and decide to watch the rest of the movie later. The user may be provided an option to mark the current playing position of the movie, or the current playing position may be saved automatically when the user moves the movie application to the to-do item list. The user may later select the item on the to-do item list and the movie application may thereby launch with the movie playing, or paused, in the stored position, so the user may enjoy the rest of the movie without having to navigate to the previously watched position. Accordingly, the user is provided with a quick way to create and select to-do items to thereby complete them.

Further, in some embodiment the to-do item manager 82 may be configured to delete to-do items 106A-C after the to-do items are selected. For instance, once the user selects a to-do item 106A-C and thereby launches the associated application 100, 200, 300 to perform the respective function, the user may no longer have a need for this to-do item. For example, the user may select the Browse Webpage X to-do item 106C, read webpage X 306A, and then no longer have any need for the to-do item because he or she has read the webpage. Accordingly, in some embodiments the to-do items 106A-C may be deleted and/or removed from the to-do list 302 by the to-do item manager 82 after the to-do items are selected. Further, in some embodiments the to-do item manager 82 may delete the to-do items 106A-C in instances in which the application performs the function using the operational characteristic, regardless of whether the to-do item is selected. Accordingly, for example, if the user opens the media player application 100 directly and plays Song 2 102B, the to-do item manager 82 may recognize that the user has used an application to perform a function using an operational characteristic as specified in a to-do item. Thereby the to-do item manager 82 may in such instances delete the to-do item 106A corresponding to the function conducted by the user. However, this may be a useable selectable option in some embodiments of the apparatus.

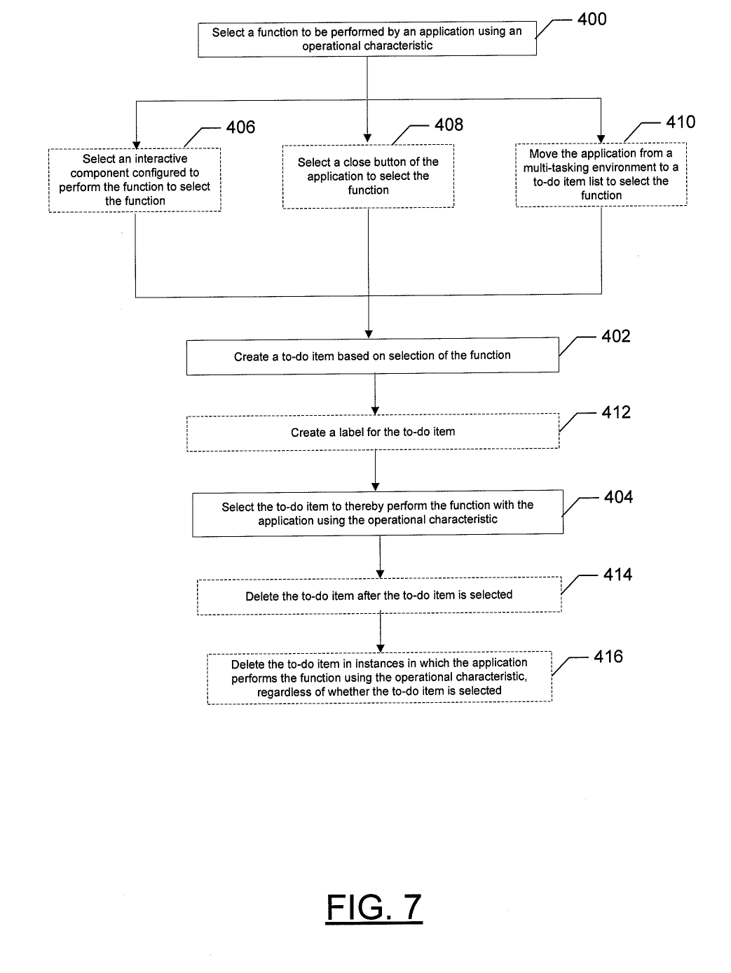

In terms of methods associated with embodiments of the present invention, the above-described apparatus 50 or other embodiments of apparatuses may be employed. In this regard, FIG. 7 is a flowchart of a system, method and program product according to example embodiments of the invention. It will be understood that each block of the flowchart, and combinations of blocks in the flowchart, may be implemented by various means, such as hardware, firmware, processor, circuitry and/or other device associated with execution of software including one or more computer program instructions. For example, one or more of the procedures described above may be embodied by a computer program product including computer program instructions. In this regard, the computer program instructions which embody the procedures described above may be stored by a memory device and executed by a processor of an apparatus. As will be appreciated, any such computer program instructions may be loaded onto a computer or other programmable apparatus (for example, hardware) to produce a machine, such that the resulting computer or other programmable apparatus embody means for implementing the functions specified in the flowchart block(s). These computer program instructions may also be stored in a computer-readable memory that may direct a computer or other programmable apparatus to function in a particular manner, such that the instructions stored in the computer-readable memory produce an article of manufacture the execution of which implements the function specified in the flowchart block(s). The computer program instructions may also be loaded onto a computer or other programmable apparatus to cause a series of operations to be performed on the computer or other programmable apparatus to produce a computer-implemented process such that the instructions which execute on the computer or other programmable apparatus implement the functions specified in the flowchart block(s).

Accordingly, blocks of the flowchart support combinations of means for performing the specified functions. It will also be understood that one or more blocks of the flowchart, and combinations of blocks in the flowcharts, can be implemented by special purpose hardware-based computer systems which perform the specified functions, or combinations of special purpose hardware and computer instructions.

In this regard, one embodiment of a method comprises providing for selection of a function to be performed by an application using an operational characteristic at operation 400. Further, the method may include creating a to-do item based on selection of the function at operation 402. Additionally, the method may include providing for selection of the to-do item to thereby perform the function with the application using the operational characteristic at operation 404.

In some embodiments, certain ones of the above-described operations (as illustrated in solid lines in FIG. 7) may be modified or further amplified. In some embodiments additional operations may also be included (some examples of which are shown in dashed lines in FIG. 7). It should be appreciated that each of the modifications, optional additions or amplifications may be included with the above-described operations (400-404) either alone or in combination with any others among the features described herein. As such, each of the other operations as will be described herein may be combinable with the above-described operations (400-404) either alone or with one, more than one, or all of the additional operations in any combination.

For example, the method may further comprise providing for selection of an interactive component of the application configured to perform the function to select the function at operation 406. In some embodiments the method may alternatively or additionally comprise providing for selection of a close button of the application to select the function at operation 408. Also, the method may alternatively or additionally comprise providing for moving the application from a multi-task environment to a to-do item list to select the function at operation 410.

Regardless of how the to-item is created, the method may further comprise creating a label for the to-do item at operation 412. Further, the method may include deleting the to-do item after selecting the to-do item at operation 414. The method may in some embodiments also comprise deleting the to-do item in instances in which the application performs the function using the operational characteristic, regardless of whether the to-do item is selected at operation 416.

In an example embodiment, an apparatus for performing the method of FIG. 7 and other methods described above may comprise a processor (for example, the processor 70) configured to perform some or each of the operations (400-416) described above. The processor may, for example, be configured to perform the operations (400-416) by performing hardware implemented logical functions, executing stored instructions, or executing algorithms for performing each of the operations. Alternatively, the apparatus may comprise means for performing each of the operations described above. In this regard, according to an example embodiment, examples of means for performing operations 400-416 may comprise, for example, the processor 70, the user interface 72, the communication interface 74, the to-do item creator 78, the application multi-tasking module 80, the to-do item manager 82, and/or an algorithm executed by the processor for processing information as described above. However, the above-described portions of the apparatus 50 as they relate to the operations of the method illustrated in FIG. 7 are merely examples, and it should be understood that various other embodiments may be possible.

In some embodiments the operation 400 of providing for selection of a function to be performed by an application using an operational characteristic may be conducted by means, such as user interface 72, to-do item creator 78, and/or the processor 70. Further, the operation 402 of creating a to-do item based on selection of the function may be conducted by means, such to-do item creator 78 and/or the processor 70. Additionally, the operation 404 of providing for selection of the to-do item to thereby perform the function with the application using the operational characteristic may be conducted by means, such as the user interface 72, the to-do item manager 82, and/or the processor 70.

Further, the operation 406 of providing for selection of an interactive component of the application configured to perform the function to select the function may be conducted by means, such as the user interface 72, the to-do item creator 78, and/or the processor 70. Also, the operation 408 of providing for selection of a close button of the application to select the function may be conducted by means, such as the user interface 72, the to-do item creator 78, and/or the processor 70. Additionally, the operation 410 of providing for moving the application from a multi-task environment to a to-do item list to select the function may be conducted by means, such as the user interface 72, the to-do item creator 78, the application multi-tasking module 80, the to-do item manager 82, and/or the processor 70. Further, the operation 412 of creating a label for the to-do item may be conducted by means, such as the to-do item creator 78 and/or the processor 70. Additionally, the operation 414 of deleting the to-do item after selecting the to-do item may be conducted by means, such as to-do item manager 82 and/or the processor 70. Also, the operation 416 of deleting the to-do item in instances in which the application performs the function using the operational characteristic may be conducted by means, such as to-do item manager 82 and/or the processor 70.

Many modifications and other embodiments of the inventions set forth herein will come to mind to one skilled in the art to which these inventions pertain having the benefit of the teachings presented in the foregoing descriptions and the associated drawings. Therefore, it is to be understood that the inventions are not to be limited to the specific embodiments disclosed and that modifications and other embodiments are intended to be included within the scope of the appended claims. Moreover, although the foregoing descriptions and the associated drawings describe example embodiments in the context of certain example combinations of elements and/or functions, it should be appreciated that different combinations of elements and/or functions may be provided by alternative embodiments without departing from the scope of the appended claims. In this regard, for example, different combinations of elements and/or functions than those explicitly described above are also contemplated as may be set forth in some of the appended claims. Although specific terms are employed herein, they are used in a generic and descriptive sense only and not for purposes of limitation.

1. An apparatus comprising at least one processor and at least one memory including computer program code, the at least one memory and the computer program code configured to, with the processor, cause the apparatus to:
provide for selection of a function to be performed by an application using an operational characteristic;
create a to-do item based on selection of the function; and
provide for selection of the to-do item to thereby perform the function with the application using the operational characteristic.

2. The apparatus of claim 1, further configured to delete the to-do item after the to-do item is selected.

3. The apparatus of claim 2, further configured to delete the to-do item in instances in which the application performs the function using the operational characteristic, regardless of whether the to-do item is selected.

4. The apparatus of claim 1, further configured to provide for selection of an interactive component of the application configured to perform the function to select the function.

5. The apparatus of claim 1, further configured to provide for selection of a close button of the application to select the function.

6. The apparatus of claim 1, further configured to provide for movement of the application from a multi-task environment to a to-do item list to select the function.

7. The apparatus of claim 1, further comprising user interface circuitry configured to:
facilitate user control of at least some functions of the apparatus through use of a display; and
cause at least a portion of a user interface of the apparatus to be displayed on the display to facilitate user control of at least some functions of the apparatus.

8. A method comprising:
providing for selection of a function to be performed by an application using an operational characteristic;
creating a to-do item based on selection of the function via a processor; and
providing for selection of the to-do item to thereby perform the function with the application using the operational characteristic.

9. The method of claim 8, further comprising deleting the to-do item after selecting the to-do item.

10. The method of claim 9, further comprising deleting the to-do item in instances in which the application performs the function using the operational characteristic, regardless of whether the to-do item is selected.

11. The method of claim 8, further comprising providing for selection of an interactive component of the application configured to perform the function to select the function.

12. The method of claim 8, further comprising providing for selection of a close button of the application to select the function.

13. The method of claim 8, further comprising providing for moving the application from a multi-task environment to a to-do item list to select the function.

14. The method of claim 8, further comprising creating a label for the to-do item.

15. A computer program product comprising at least one computer-readable storage medium having computer-executable program code portions stored therein, the computer-executable program code portions comprising:
program code instructions providing for selection of a function to be performed by an application using an operational characteristic;
program code instructions for creating a to-do item based on selection of the function; and
program code instructions providing for selection of the to-do item to thereby perform the function with the application using the operational characteristic.

16. The computer program product of claim 15, further comprising program code instructions for deleting the to-do item after selecting the to-do item.

17. The computer program product of claim 15, further comprising program code instructions providing for selection of an interactive component of the application configured to perform the function to select the function.

18. The computer program product of claim 15, further comprising program code instructions providing for selection of a close button of the application to select the function.

19. The computer program product of claim 15, further comprising program code instructions providing for moving the application from a multi-task environment to a to-do item list to select the function.

20. The computer program product of claim 15, further comprising program code instructions for creating a label for the to-do item.
